(19) United States
(12) Patent Application Publication
(10) Pub. No.: US 2018/0229544 A1
(43) Pub. Date: Aug. 16, 2018

(54) Method for Creating a Decorative Item

(71) Applicant: Katherine Cross, St. Clair Shores, MI (US)

(72) Inventor: Katherine Cross, St. Clair Shores, MI (US)

(21) Appl. No.: 15/434,100

(22) Filed: Feb. 16, 2017

(51) Int. Cl. B44C 3/02; B44C 3/12

(52) U.S. Cl. CPC B44C 3/025; B44C 3/12

(57) ABSTRACT

A method creates a decorative item to be secured to a host item, such as a gift, begins with selecting a piece of card stock that extends through only two dimensions. The method then includes the step of manipulating the piece of card stock to create a manipulated piece of card stock extending through three dimensions. The three-dimensionally manipulated piece of card stock is then secured to a host item or gift packaging as decorative alternative to a ribbon and/or a bow.

### BACKGROUND ART

### 1. Field of the Invention

The invention relates to a method of decorating an item such as a gift. More particularly, the invention relates to a method for fabricating a decoration to replace a bow and/or a ribbon on a gift, whether wrapped or not.

### 2. Description of the Related Art

The age-old tradition of decorating gifts has included wrapping the gift and tying a ribbon around the gift and/or securing a bow thereto. While people are very creative in how they wrap a gift, they are still limited by those three devices to decorate a gift.

### SUMMARY OF THE INVENTION

A method for creating a decorative item to be secured to a host item such as a gift begins with selecting a piece of card stock that extends through only two dimensions. The method then includes the step of manipulating the piece of card stock to create a manipulated piece of card stock extending through three dimensions. The manipulated piece of card stock is then affixed to the host item.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view of a first step in the inventive method;

FIG. 2 is a perspective view of a second step in the inventive method;

FIG. 3 is a perspective view of a third step of the inventive method; and

FIG. 4 is a perspective view of an alternative embodiment created by the inventive method and secured to a host item.

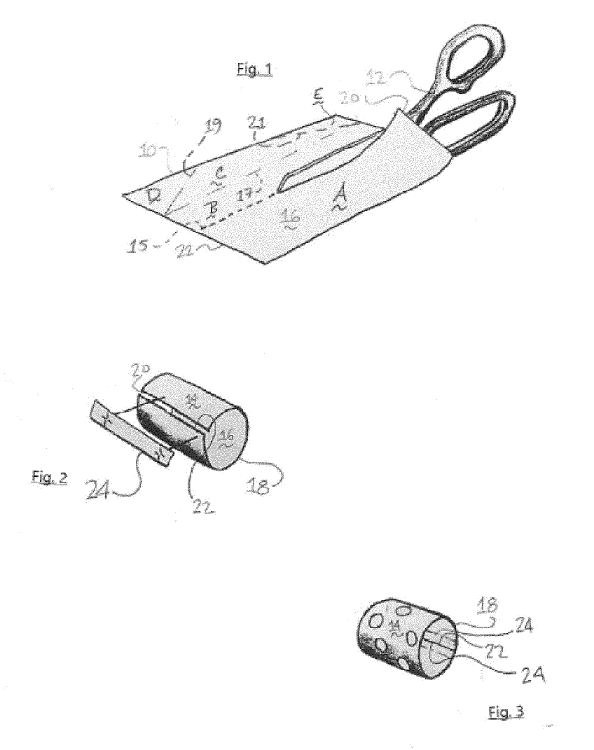

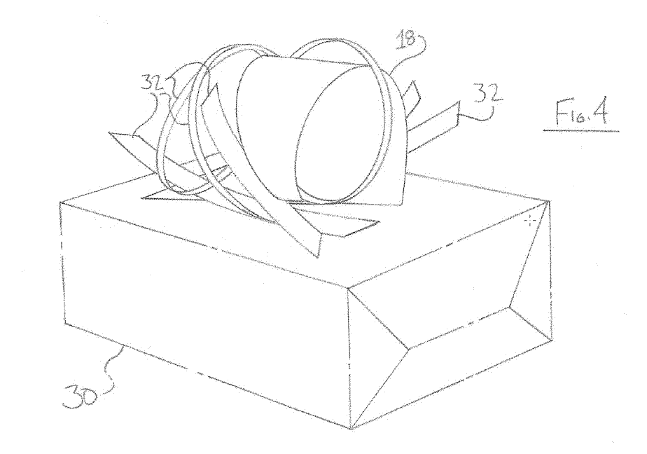

### DETAILED DESCRIPTION OF THE DRAWINGS

Referring to the Figures, the inventive method begins with a piece of card stock 10. The card stock 10 may be of any thickness desired by the person engaged in performing the method. In one embodiment, the card stock is 60 lb Laser Cover LZ60. Initially, the card stock 10 is flat, i.e., it extends through only two dimensions at a size of 5.5″×8.5″.The size, or the person may use a pair of scissors 12 to cut the card stock 10 along a line represented by a dashed line 15. If desired, the person may also cut the card stock 10 along other various lines that are represented in FIG. 1 by dashed lines 17, 19, 21 to make a plurality of shapes A, B, C, D, E. It will be appreciated by those skilled in the art that the dashed lines 15, 17, 19, 21 and shapes A, B, C, D, E are exemplary as many different cut lines and shapes can be created by varying the cut lines.

Because the card stock 10 has two faces 14, 16, each may have a printed pattern/decoration different from the other. The selection of the printed pattern on the two surfaces 14, 16 will determine the orientation of the card stock 10 with respect as to how the card stock 10 is positioned when it is being manipulated (discussed below).

The card stock 10 is manipulated into three dimensions so the card stock 10 takes on a shape. The manipulation of the card stock 10 may include rolling the card stock 10 into a cylindrical tube 18. Other manipulations may include, but are not limited to, making rectangular tubes, zig-zag folding patterns, a random folding scheme, solid objects (cubes, pyramids), and the like.

As is shown in FIG. 4, the manipulations may include several of these shapes. The three-dimensional object 18 may then be secured to the host item, e.g., a gift 30. The resulting three-dimensional object 18 may include more than one piece of card stock 10. For example, a cylindrical tube 18 may be matched with other pieces of card stock 32 that are looped in varying degrees in a manner that accents the base shape, which in this instance, is the cylindrical tube 18.

Regardless of the configuration of the three-dimensional objects 18, 32, a portion of the card stock 10 is secured to the host item 30. The three-dimensional objects 18, 32 could be laid across the host item 30 or it could extend out and away from the host item 30 before it is secured to the host item 30. Said another way, the three-dimensional objects 18, 32 may be laid down across a portion of the host item 30 and secured thereto, or they may be secured to the host item 30 on end.

Once the three-dimensional piece(s) of card stock 10 is(are) formed, it may be adhered to itself to maintain its shape. In the instance of where the card stock 10 is a tube or roll 18, one edge 20 of the card stock 10 is secured to another edge 22 using a piece of tape 24 or glue (not shown).

Once the three-dimensional structure 18, 32 is completed, it is secured to its host item 30. The step of securing the three-dimensional structure is done in a traditional manner, using glue or tape.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

I claim:

1. A method for creating a decorative item to be secured to a host item, the method comprising the steps of:
selecting a piece of card stock extending through only two dimensions;
manipulating the piece of card stock to create a manipulated piece of card stock extending through three dimensions; and
securing the manipulated piece of card stock to the host item.

2. A method as set forth in claim 1 wherein the step of manipulating includes a step of rolling the piece of card stock.

3. A method as set forth in claim 1 wherein the step of manipulating includes a step of folding the piece of card stock.

4. A method as set forth in claim 1 including a step of adhering one portion of the piece of card stock to another portion thereof to maintain the extension of the manipulated piece of card stock through the three dimensions.

5. A method for creating a decorative item to be secured to a host item, the method comprising the steps of:
cutting a first piece out of card stock extending through only two dimensions;
cutting a second piece out of the card stock extending through only two dimensions;
manipulating the first and second pieces of card stock to create a manipulated pieces of card stock having a first shape and a second shape, respectively, each extending through three dimensions, wherein the second shape differs from the first shape; and
securing the manipulated piece of card stock to the host item.
